(19) United States
(12) Patent Application Publication
(10) Pub. No.: US 2010/0318967 A1
(43) Pub. Date: Dec. 16, 2010

(54) SUPPLEMENTARY DEPLOYMENT ACTIONS

(75) Inventors: Saurabh Bhatia, Bellevue, WA (US); Jeffrey S. Young, Snoqualmie, WA (US); David Andrew Whitechapel, Seattle, WA (US); Konstantin Eman, Kirkland, WA (US); Jiajun Hua, Redmond, WA (US); Thomas Quinn, Seattle, WA (US); Rachel Falzone Schaw, Seattle, WA (US); Rolando Jimenez Salgado, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/483,273

(22) Filed: Jun. 12, 2009

(51) Int. Cl. G06F 9/44

(52) U.S. Cl. 717/122

(57) ABSTRACT

A system and method for enabling supplementary deployment actions to be performed in conjunction with a deployment of an application version. A deployment manager may download one or more supplementary deployment action (SDA) components to a user application cache. In conjunction with performing deployment actions, SDA components may be invoked from the user application cache or from a global application cache. The SDA components may perform actions specific to the application or version of the application, including actions not preconfigured in the deployment manager. An SDA component may be invoked prior to or after the deployment manager performs deployment actions. If an SDA component fails, SDA components that succeeded may be automatically invoked to roll back their actions. SDA components may be used to perform a first install, an update, a roll back, or an uninstall. SDA components may have the privileges of the application and the user corresponding to the user application cache.

### BACKGROUND

Many application programs provide a mechanism to enable add-in programs to supplement the operation of the “host” application program. The add-in programs may provide additional features or enhance features of the host program. By publishing an interface, third parties may provide such add-in programs. Microsoft Office applications are examples of host applications that interoperate with add-in programs.

Click-once is an application deployment technology that allows an application developer to publish a stand-alone application or an add-in application to a server or storage location for installation by users. The technology includes a mechanism for automatically updating the application on the user's device when a new version is published. An application publisher copies the application files to a deployment location. The publisher creates a manifest that lists the application files, and copies the manifest to a deployment location. A client device can install the application by retrieving the manifest and then downloading the application files. The publisher can publish an update version in a similar manner, copying updated files and a corresponding manifest to a deployment location. The client device can check whether an update is available, and then download the updated files. The click-once framework allows an application developer to publish an application without distributing an installation program.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to enable supplementary deployment actions to be performed in conjunction with a deployment of an application version. In one embodiment, a computing device has a user application cache corresponding to each user, a set of privileges corresponding to each user, and a global application cache for use by a group of users. In one embodiment, a set of application files is retrieved to the user application cache, the application files including a manifest file that specifies at least one supplementary deployment action (SDA) component. A deployment manager on the computing device may perform deployment actions corresponding to the version of the application. In one embodiment, for each SDA component specified by the manifest file, actions include selectively retrieving the SDA component to the user application cache, selectively invoking the SDA component from the user application cache, selectively invoking the SDA component from the global cache, and selectively configuring the application to use the set of application files.

In one embodiment, if an SDA component is retrieved to the user application cache, it is invoked from the user application cache; if not, it is invoked from the global application cache.

In one embodiment, deployment actions are performed in accordance with a set of privileges corresponding to the user and the application, and each SDA component is restricted based on the set of privileges.

In one embodiment, the manifest file may specify whether an SDA component is to be invoked prior to the deployment actions of the deployment manager or after the deployment actions of the deployment manager.

In one embodiment, if an SDA component fails during an install, SDA components that have succeeded during the install are invoked and instructed to roll back the actions that they performed. Monitoring for failure and invoking the SDA components for the roll back may be performed automatically, without user intervention. If the install is an initial install of the application, the SDA components may be instructed to perform actions to uninstall the application, reversing at least some of the actions that they performed.

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of an example environment in which embodiments may be practiced;

FIG. 2 is a block diagram illustrating an example embodiment of a deployment system that may be employed to deploy an application;

FIG. 3 is a block diagram illustrating an example embodiment of a user application cache;

FIG. 4 is a flow diagram illustrating an example embodiment of a process for installing an application; and

FIG. 5 is a flow diagram illustrating an example sequence that may occur with an SDA component failure in one specific configuration.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “pointer” refers to a reference to a target physical or logical memory location, data structure, program instruction, or program segment. A pointer “points to” a target and may be used to locate or obtain the target. A pointer may be implemented in a variety of ways, including an address, an offset, an index, or an identifier. It may be used to identify or locate a node of a graph structure.

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

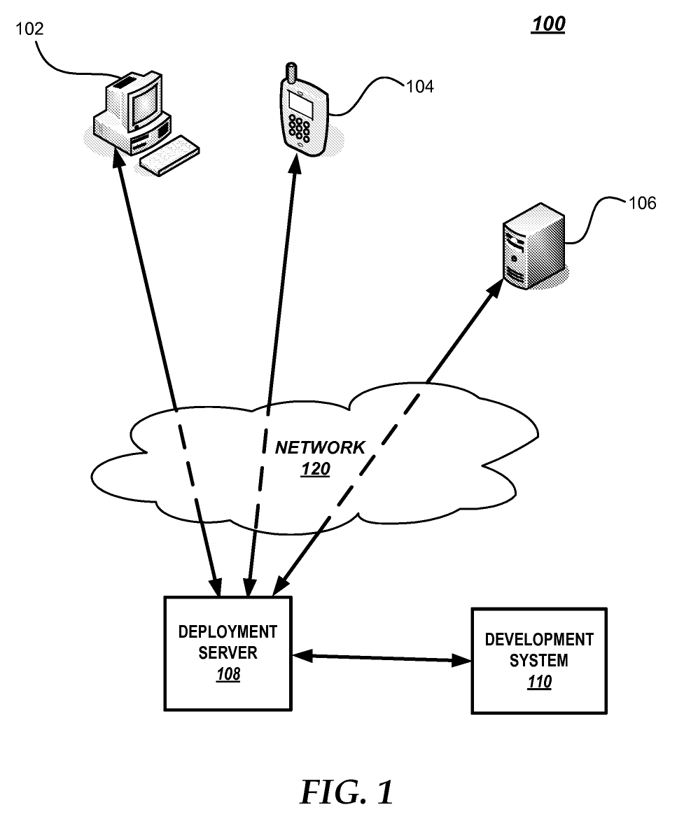

FIG. 1 is a block diagram of an example environment 100 in which embodiments may be practiced. FIG. 1 provides a basic understanding of an example environment, though many configurations may be employed and many details are not illustrated in FIG. 1. As illustrated in FIG. 1, an example environment 100 includes clients 102, 104, and 106. Each of clients 102-106 may be a client computing device, process, or any component that requests access to stored data. In the example embodiment, client 102 is illustrated as a personal computer, client 104 is illustrated as a mobile communication device, and client 106 is illustrated as a server, in order to show the variety of clients that may exist. Other computing devices or processes may be clients in various environments. Each client may have one or more associated users that interact with the client.

Example environment 100 includes deployment server 108. Deployment server 108 may be a computing device, server, or a server farm that includes multiple servers, or a process executing thereon. Deployment server 108 may include a Web server, an FTP server, or other type of server. Deployment server 108 may be a network file share in a local area network or another type of network. Deployment server 108 may store files or other data for installation on one of clients 102-106. Deployment server 108 may receive a request to install or update an application residing on one of clients 102-106 and, in response, perform actions to facilitate the installation or update, such as downloading files to the client.

In the illustrated example environment, deployment server 108 communicates with development system 110. Development system 110 may be one or more client computing devices, one or more servers, a process executing thereon, or a combination thereof. Development system 110 may be used by one or more developers to develop application programs or associated files or data.

Each of clients 102-106 may communicate with deployment server 108 through direct connections or a network 120. Network 120 may include a local area network, a wide area network, or a combination thereof. In one embodiment, network 120 includes the Internet, which is a network of networks. Network 120 may include wired communication mechanisms, wireless communication mechanisms, or a combination thereof. Communications between clients 102-106 and deployment server 108, with each other or other computing devices may employ one or more of various wired or wireless communication protocols, such as IP, TCP/IP, UDP, HTTP, SSL, TLS, FTP, SMTP, WAP, Bluetooth, or WLAN.

As used herein, the term “application” refers to a computer program or a portion thereof, and may include associated data. An application may be an independent program, or it may be designed to provide one or more features to another application. An “add-in” and a “plug-in” are examples of applications that interact with and provides features to a “host” application.

An application is made up of any combination of application components, which may include program instructions, data, text, object code, images or other media, security certificates, scripts, or other software components that may be installed on a computing device to enable the device to perform desired functions. Application components may exist in the form of files, libraries, pages, binary blocks, or streams of data. Application components may be distributed from various locations, and may be integrated with components of other applications or of the computer system. Examples of application components include object files, libraries, COM objects, code assemblies, global assembly cache components, markup language pages or templates, system registry entries, entries in configuration or system files, or the like. Components of an application are also referred to as application “content.”

As used herein, a version of an application may refer to an application, or any subset of one or more components of an application, in which any of the components may be a variation of a previous version of the component. A version may include components that are the same or a variation of a previous version. A revised version of a component may be deployed to an application, causing the entire application to be considered a new version. For illustrative purposes, components of an application are assigned a version number when they differ from a previous version, and an application is labeled by the version number of its most recently changed or added component. For example, when an application version 1 (V1) receives a component that is labeled version 2 (V2), the application is labeled as version 2 (V2). There exist many ways to label versions of an application or its components. The labels used herein are to assist in description, and are not intended to limit the invention. Further, a label of first version (V1) is used to identify and distinguish a version, and does not necessarily indicate that there have not been prior versions.

In one example configuration, any one of clients 102-106 may send a request to deployment server 108 for an application version to be installed on the client device. As used herein, the phrase “installing” an application version on a device may refer to a new install or an update to a previously installed application. Generally, with a new install the client device does not include a version of the application, or at least the user associated with the new install does not have a version of the application installed. There may, however, be a configuration in which a user has a previous version of the application, but it is maintained separately, so that an installation functions as a new install. In an update, the client device has a version of the application, and a different application version, or a portion thereof is installed. In an update, at least some existing files or data from a previous version may be maintained and used with the updated version.

In response to a request from a client application, deployment server 108 may perform various actions, such as authenticating or authorizing the client or user, maintaining accounting information, or logging activity. In one example configuration, development system 110 may transfer application files or associated data to deployment server 108. The application files may represent an application that does not exist on deployment server 108, an application that may be installed and associated with a different user, or a new version of an application that already exists and is associated with the current user on deployment server 108. The processes of installing an application, and associated actions on deployment server 108 or one of clients 102-106, is referred to as “deployment” of the application or application version.

FIG. 1 is only an example of a suitable environment and is not intended to suggest any limitation as to the scope of use or functionality of the present invention. Thus, a variety of system configurations may be employed without departing from the scope or spirit of the present invention. For example, any of the functions of deployment server 108 may be combined into one or more computing devices, distributed, or replicated among multiple computing devices in a variety of ways.

In one embodiment, each of clients 102-106, deployment server 108, and development system 110 is implemented by one or more computing devices. A computing device may be a special purpose or general purpose computing device. In brief, one embodiment of a computing device that may be employed includes one or more processing units, a memory, a display, keyboard and pointing device, and a communications interface. The one or more processing units may include one or more single or multiple core processors. Example computing devices include mainframes, servers, blade servers, personal computers, portable computers, communication devices, consumer electronics, or the like. A computing device may include a general or special purpose operating system. The Windows® family of operating systems, by Microsoft Corporation, of Redmond, Wash., are examples of operating systems that may execute on a computing device of a development system.

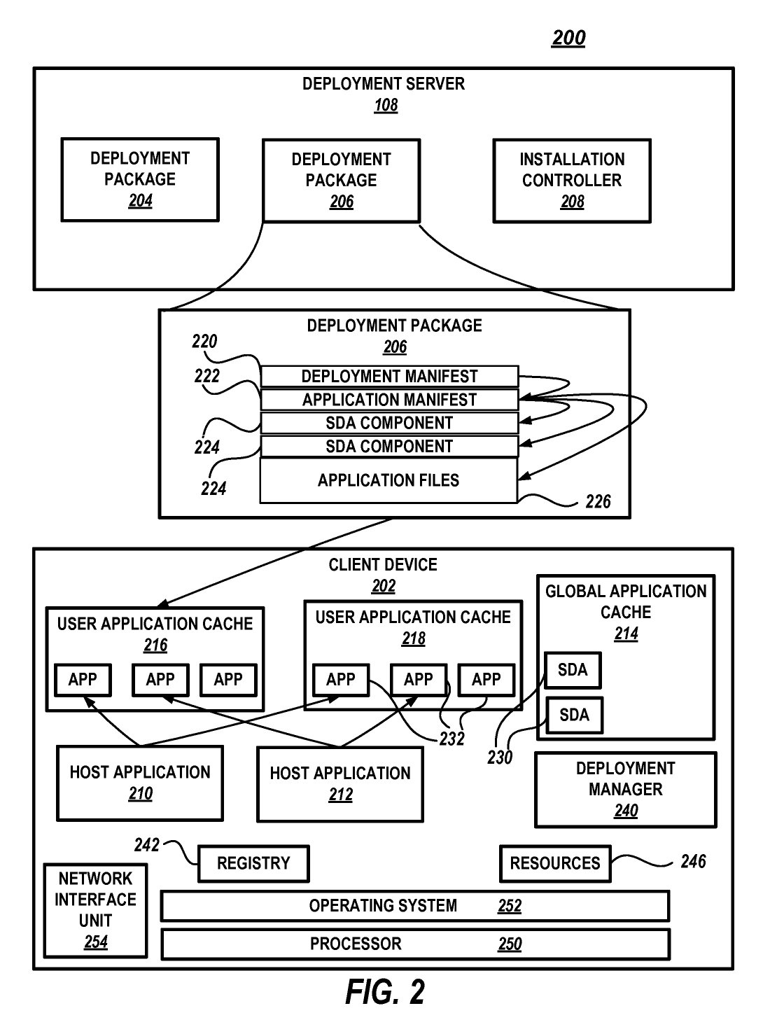

FIG. 2 is a block diagram illustrating an example embodiment of a deployment system 200 that may be employed to deploy an application. In various embodiments, deployment system 200 may be implemented with one or more servers or other computing devices configured in a variety of ways.

As illustrated, deployment system 200 includes deployment server 108 and client device 202. Client device 202 may be any of clients 102-106 of FIG. 1, or another client device. In one embodiment, deployment server 108 stores one or more deployment packages 204-206 and installation controller 208. Deployment server 108 may have an integrated computer storage or external computer storage. In one embodiment, deployment server 108 refers to one or more computing devices implementing deployment server 108, including one or more external storage devices.

In one embodiment, each of deployment packages 204-206 includes files or data for downloading to client device 202 as part of an application deployment. In one implementation, an entire deployment package may be downloaded to client device 202, though in some implementations, a portion of deployment package may not be downloaded.

The exploded view of deployment package 206 illustrates at least some of the contents of an example deployment package. Deployment package 206 may be a logical package, in that the contents may be distributed in a computing device or across multiple computing devices. At least a portion of deployment package 206 may reside on one or more servers, and at least a portion may reside in one or more network file shares. In the illustrated example, deployment package includes a deployment manifest 220, an application manifest 222, one or more supplemental deployment action (SDA) components 224, and one or more application files 226. Each of these components may comprise one or more files, including executable, binary or text files. In one implementation, each of deployment manifest 220, application manifest 222, and SDA components 224 include content in a structured markup format, such as eXtensible markup language (XML). In one embodiment, one or more SDA components 224 may be integrated with an executable application file 226. For example, an SDA component 224 may be implemented as a class within an application assembly, where the assembly is one of the application files 226. Invoking an SDA component may include invoking instructions in the assembly that implement the SDA component.

Deployment manifest 220 may include a pointer to application manifest 222. Application manifest 222 may include pointers to each of SDA components 224 and each application file 226. In one implementation, one or more of these pointers comprises a string that identifies a file name of the target component. In one implementation, a pointer to an SDA component may specify a class name corresponding to the SDA component. As discussed herein, an ordering of the pointers may have significance in one or more of the deployment processes. For example, an ordering of SDA component pointers may specify an ordering in the invocation of the respective SDA components. In one implementation, a process may use deployment manifest 220 to identify and locate each other component of deployment package 206.

Deployment manifest 220 may include additional information. It may include, for example, one or more of digital signature data, version identification, publisher identification, an application name, an identification of the application creator, or other information. The version identification may be used to identify the particular application version represented by deployment package 206.

Application manifest 222 may include data specifying a frequency or schedule to check for updates. Application manifest 222 may include a list of file names corresponding to application files 226. The downloading process may use this list to identify the application files that are to be downloaded. Application manifest 222 may include a list of one or more SDA components, though some deployment packages may have no SDA components. In one implementation, each SDA component 224 is characterized in a way that provides information of when or how to invoke the SDA component, or when to download the SDA component. For example, in one embodiment, an SDA component may be a pre-deployment SDA component or a post-deployment SDA component. A pre-deployment SDA component may be downloaded and invoked prior to downloading application files 226. A post-deployment SDA component may be invoked after downloading application files 226. In one implementation, the characterization of the SDA component may be indicated by a location, grouping, node, or other identifier in application manifest 222.

Each SDA component 224 may comprise an executable program, such as a DLL or other executable file. In one implementation, an SDA component may be a script or set of instructions that are interpreted by another mechanism. In some configurations, an SDA component specification may identify an SDA component that is previously installed on a client device, such as in a global application cache. An SDA component specification may identify an SDA component but not specify the component location, the location determined by heuristics, such as those explained herein.

Application files 226 may include one or more of executable program files, image files, audio files, video files, text files, markup language files, resource files, or files of any other format. The set of application files 226 corresponds to an application version of deployment package 206. Some application files may have changed since a prior version, though some application files may not have changed.

In the illustrated embodiment, client device 202 includes host applications 210-212, user application caches 216-218, and global application cache (GAC) 214.

In one embodiment, each user application cache 216-218 is a logical area of storage that is physically stored in non-volatile memory. Each user application cache corresponds to a single user, and GAC 214 corresponds to a group of users. Operating system 252 or another mechanism may maintain a set of privileges and restrictions for each user and for each application. A privilege is a right to perform an action or access a resource. In one embodiment, each user has a privilege to access the contents of the user's UAC, and is restricted from accessing another user's UAC. A user application cache (UAC) 216-218 includes content that is specific to the corresponding user. Thus, a first user may be protected from changes that a second user may make to the second user's UAC. In the illustrated embodiment, each user application cache 216-218 includes applications 232 that are associated with one of host application 210 or host application 212. An application 232 may be independent, and not associated with a host application.

GAC 214 may contain application files, including executable files or data files. It may include one or more SDA components 230. In one embodiment, each of the SDA components 230 may be invoked during an installation of any application. In one embodiment, each of the SDA components 230 may be invoked during an installation of an application to the UAC of any user in the group that corresponds to the GAC. The group of users that corresponds to GAC 214 may be all users of client device 202 or a subset thereof. In various embodiments, the correspondence between UACs and users, or GAC 214 and users may vary. For example, in one embodiment, a UAC may correspond to a plurality of users; in one embodiment, client device 202 may include multiple GACs 214, each GAC corresponding to a group of users. These variations may apply to any of the discussion herein, unless clearly indicated otherwise.

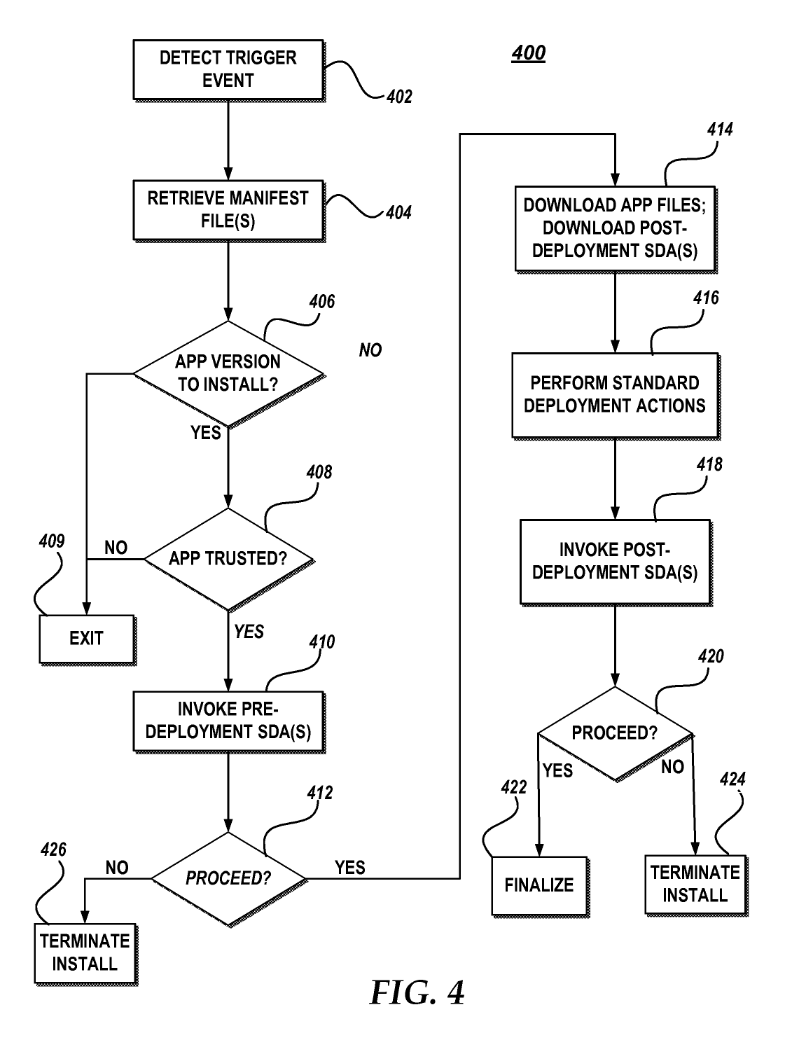

In the illustrated embodiment, client device 202 includes deployment manager 240, which manages downloading files, creating folders, and other deployment actions. At least some of the actions of deployment manager 240 are discussed with respect to FIG. 4. Client device 202 may also include one or more of registry 242 or other resources 246. SDA components 224 may retrieve data from or modify the registry, or various other resources. In one embodiment, deployment manager 240 may modify one or more entries in registry 242.

The illustrated embodiment of client device 202 also includes one or more processors 250 and operating system 252. One embodiment of a client device may include a network interface unit 254, drivers, or other software for communicating with remote devices. The computing device may employ one or more of various wired or wireless communication protocols, such as IP, TCP/IP, UDP, HTTP, SSL, WAP, Bluetooth, or the like. Communications may use direct connections, local area networks, wide area networks such as the Internet, wireless networks, or a combination thereof.

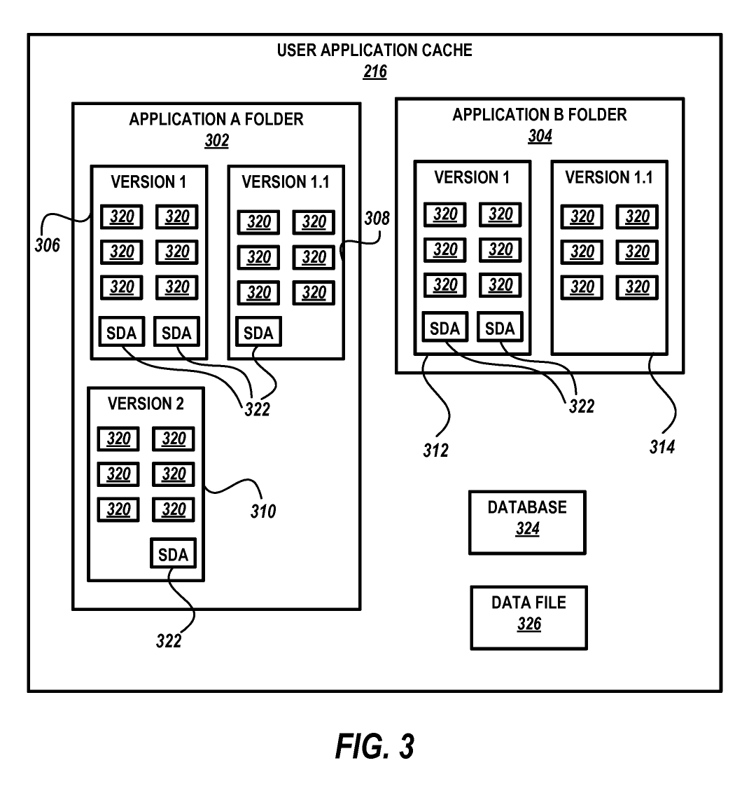

FIG. 3 is a block diagram illustrating an example embodiment of user application cache (UAC) 216 of FIG. 2. A UAC may be divided into multiple, nested groupings, referred to herein as folders. A folder may be any type of physical or logical grouping, and may employ a directory structure or another mechanism for maintaining containers. A UAC may be subdivided into a folder for each application. In the illustrated configuration, UAC 216 includes application folder 302 for application A and application folder 304 for application B. Each application folder may contain folders for each of multiple versions of the application. As illustrated, application folder 302 contains version folders 306, 308, and 310, for versions 1, 1.1, and 2, respectively. Within each version folder, corresponding files that are downloaded from the deployment server are stored. This may include application files 320, SDA components 322, or other files. Application files 320 may be application files 226, of FIG. 2. SDA components 322 may be SDA components 224. As discussed herein, an SDA component 322 may be integrated with an application file 320, such as a class within an assembly, or a portion thereof. As illustrated, each version folder may include a different set of SDA components than other version folders.

In the illustrated configuration, application folder 304 contains version folders 312 and 314 for versions 1 and 1.1, respectively. Version folder 312 includes application files 320 and SDA components 322. Version folder 314 includes application files 320 and no SDA components.

In one embodiment, an installation process includes creating a version folder corresponding to the deployment package 206. The folder may be named to correspond to the version identifier, which may be contained in the application manifest. In one embodiment, prior version folders are maintained, where they may be used in the event of a roll back. For example, if an installation of application A version 2 fails, a roll back to version 1.1 may be performed, such that the files of version folder 308 are used by the application. In one embodiment, prior version folders may be deleted after an update or on command by a user.

User application cache 216 may include any number of files of various types. Examples of this include database files or data files. The example embodiment of UAC 216 in FIG. 3 includes a database 324 and data file 326, though various configurations may include more or less files. Each of these components may include data that is used by an application. The data may include user-specific data and any other data that is not necessarily user-specific. Deployment manager 240 or SDA components 322 may retrieve, store, or modify data in database 324 or data file 326 during a deployment process.

FIG. 4 is a flow diagram illustrating an example embodiment of a process 400 for installing an application. In one embodiment, at least a portion of the actions of process 400 are performed by client device 202, in conjunction with deployment server 108.

The illustrated portions of process 400 may be initiated at block 402, where an event triggers an application installation. The event may be a user action, such as entering an install command. The event may be related to a timer or a schedule, such as a configured amount of time since a previous update of the application, a calendar date or time, or the like. The event may be a system startup, the application startup, the startup of a related application, an invocation of a feature of an application, or the like. In one embodiment, the event may be a message or signal received from a process or a remote device. Any one or more of these examples, or another event, may trigger the application installation.

Process 400 may flow to block 404, where one or more manifest files may be retrieved. In one embodiment, client device may retrieve deployment manifest 220 from deployment server 108. Using a pointer in deployment manifest 220, application manifest 222 may be retrieved.

The process may flow to decision block 406, where a determination is made of whether to proceed with an application installation. In one embodiment, information in application manifest 222 or deployment manifest 220 may be used to determine whether to proceed with an application installation. For example, the information may indicate whether there is an update version available that is not already installed for the current user. If not, the process may proceed to block 409, where the process exits without performing an installation. In some embodiments, the actions of block 406 may include determining whether to proceed based on other factors.

If it is determined to proceed at decision block 406, the process may flow to decision block 408, where a determination of whether to trust the application may be made. Information in deployment manifest 220 or application manifest 222 may indicate whether the deployment package or the corresponding application version is trusted by the current user. This information may include a digital signature or other cryptographic data indicative of authenticity or integrity of the application version. Other criteria may be considered in a determination of whether to trust the deployment package 206. If the deployment package or application version is not trusted, the process may flow to block 409, where the process exits without performing an installation.

If it is determined that the deployment package or application version is trusted, the process may flow to block 410, where one or more SDA components that are characterized as pre-deployment SDA components may be invoked, based on SDA component information in application manifest 222. In one embodiment, invoked pre-deployment SDA components reside in global application cache 214, where they were installed prior to process 400. In one embodiment, each such SDA component is invoked sequentially, in an order specified in application manifest 222, such as a sequential list. Techniques for invoking an SDA component are discussed in further detail herein. A pre-deployment SDA component may perform any of a variety of actions, such as moving or copying files, modifying system registry settings, modifying a database, or determining whether a configuration is suitable for an installation. A pre-deployment SDA component may communicate with a post-deployment SDA component, for example, by writing to a file or setting a registry value that the post-deployment SDA later reads.

The process may flow to decision block 412, where a determination is made of whether to proceed with the installation, based on actions of the pre-deployment SDA components. An invoked SDA component may return a status value that indicates whether to proceed with the installation or abort it. This determination may be made based on any of a number of factors. A failure by a pre-deployment SDA component does not necessarily indicate that the installation is to be aborted. In one embodiment, an SDA component may return a status value that indicates one of success, failure, and another status value of proceed or abort. In one embodiment, a pre-deployment SDA component does not have an option to abort the install. If it is determined to abort the install, the process may flow to block 426, where the installation is terminated. As discussed herein, terminating an installation may include rolling back the configuration to a previous version or uninstalling the incomplete installation. This may include invoking the pre-deployment SDA component to perform such actions.

If all invoked pre-deployment SDA components indicate a status to proceed, the process may flow to block 414, where application files 226, as specified by application manifest 222, may be retrieved from deployment server 108. In one embodiment, retrieving each file includes receiving each file and installing it into the corresponding user application cache 216 or 218. SDA components 224 that are characterized as post-deployment SDA components may also be retrieved and installed into the corresponding user application cache. In one embodiment, application files and SDA components are installed into a version folder, such as version folder 310 of FIG. 3.

The process may flow to block 416, where standard deployment actions may be performed. In one embodiment, deployment manager 240 is configured to perform the standard deployment actions. These actions may include moving one or more application files or modifying one or more user-specific registry keys, based on a configuration of deployment manager 240.

In one embodiment, standard deployment actions may include copying or moving files from a previously installed version. For example, during an update install to version 2 of application A in FIG. 3, updated application files 320 may be retrieved and placed in version folder 310. Application files 320 from the previous version (version 1.1) in version folder 308 that do not have a corresponding file in the current deployment package may be copied or moved into the version folder of version 2. Thus, a version folder may have a complete set of application files, and files that are not updated do not need to be included in a deployment package. In one embodiment, application manifest 222 may indicate the files that are to be copied or moved into the current version folder. In one embodiment, application manifest 222 may indicate the files that are not to be copied or moved in the current version folder, for example if an update version does not use a file from a previous version.

The process may flow to block 418, where one or more SDA components characterized as post-deployment SDA components are invoked. In one embodiment, for each post-deployment SDA component identified in application manifest 222, deployment manager 240 attempts to invoke the SDA component in the user's UAC. If the SDA component is not present in the UAC, deployment manager 240 invokes the SDA component in GAC 214. Thus, at least some of the mechanisms described provide several options. One option is to employ an SDA component installed in the GAC. A second option is to include in the deployment package an SDA component that is not installed in the GAC. A third option is to override an SDA component in the GAC by including an SDA component with the same identifier in the deployment package.

A post-deployment SDA component may perform any of a variety of actions. Actions may include moving or copying application files to a specified location that complies with the user and application privileges.

The process may flow to decision block 420, where a determination is made of whether to proceed with the installation, based on actions of the post-deployment SDA components. As discussed with respect to decision block 412, a determination of whether to proceed may be based on any of a number of factors. Also, as discussed with respect to pre-deployment SDA components, in some embodiments an installation may proceed even though one or more post-deployment SDA components fail. If it is determined to abort the install, the process may flow to block 424, where the installation is terminated.

If all invoked post-deployment SDA components indicate a status to proceed, the process may flow to block 422, where the installation is finalized and a commit is performed. In one implementation, this may include setting a registry value, pathname, or other flag that indicates the application is to use the files and data of the just installed version. In one embodiment, the files of the prior version remain in the user's UAC, where they may be used if a subsequent roll back is performed.

In one embodiment, each SDA component is provided with privileges that match the privileges of the instance of the application being installed. These privileges may define file access permissions, registry key access permissions, or access to other resources. In one embodiment, the instance of the application being installed by a current user has privileges that enable accesses to specific files or folders, according to a configuration. For example, in one configuration, the privileges may specify permission to read or write files within the users UAC and a user folder. The SDA component invoked by the user may then have the same file access permissions. Similarly, a user and application may have privileges to access certain registry keys. An SDA component invoked by the user during installation of the application has these privileges. As another example, a database that is accessible to a user may be accessed by an SDA component invoked by the user during an installation. If the access includes modify rights, the SDA component is provided with rights to modify. This inheritance of privileges may apply whether the SDA component resides in the user's UAC or in the GAC when it is invoked.

The application may have privileges that extend beyond the privileges of the deployment manager. In one embodiment, an SDA component with privileges of the user and the application may thus perform actions that are unavailable to the deployment manager. For example, an SDA component may have rights to move files to a user folder that is not accessible to the deployment manager. An SDA component invoked by a user during an application installation may have rights to access a database or other user data that is not accessible to the deployment manager.

The privileges that an SDA component may employ may be based on the current user and the application being installed. For example, an SDA component invoked from the GAC may have a first set of privileges when invoked by a first user to install Application A, a second set of privileges when invoked by the first user to install Application B, and a third set of privileges when invoked by a second user to install Application A. The set of privileges may be the same set of privileges that the application has when executed by the user.

Actions performed by an SDA component may include setting or modifying system registry key values that correspond to the user. In one example, an SDA component may retrieve a folder location from a registry key and move or copy application files to the folder location. Another example of SDA component actions includes adding data to a user database or otherwise modifying a user database or related data. An SDA component may compare data in application files with a user database for compatibility. The SDA component may selectively modify the application files or the database to achieve compatibility. This may include modifying the database schema or merging the application data with the database. In another example, an SDA component may communicate with a remote computing device or Web service to request a service or resource or perform another action.

An SDA component may perform actions based on an action performed by a previous SDA component. For example, a pre-deployment SDA may write to a file or a registry. A post-SDA component may subsequently read the file or registry and perform an action based on the content left by the pre-deployment SDA. In one configuration, this mechanism may enable an SDA retrieved to the user application cache to control actions by a subsequent SDA invoked from the GAC.

In one embodiment, an SDA component employs an invocation mechanism in which the SDA component implements an interface defined to be compatible with deployment manager 240. In one implementation, the interface includes an “execute” method that is invoked. Upon invocation of this method, an SDA component may perform appropriate actions. In one implementation, the execute method includes an argument that indicates whether the SDA component is being invoked as part of an initial installation, an update, a roll back, or an uninstall. The SDA component may then perform actions corresponding to the specified type of invocation, based on this argument.

Table 1 includes arguments that may be passed to an execute method of an SDA component, in an example implementation, with a corresponding explanation of each argument. In various implementations, there may be additional arguments, or a different set of arguments. In some implementations, the invocation structure may differ. For example, in one implementation, an SDA component may implement multiple methods, each method corresponding to a type of installation, such as initial install, update, roll back, and uninstall. In some implementations, other techniques may be employed to pass information to an SDA component.

TABLE 1
Example SDA Component Invocation Arguments

| | |
|---|---|
| URI manifest | URL for the deployment manifest |
| string ApplicationManifestXml | Complete XML of the Application |
| | Manifest |
| string DeploymentManifestXml | Complete XML of the Deployment |
| | Manifest |
| string HostManifestXml | “Host” manifest xml |
| InstallationStatus | Indicates the context of the |
| | invocation. Includes the |
| | following options: |
| | InitialInstall - During first install |
| | Update - During Update |
| | Uninstall - When Add-in is uninstalling |
| | Rollback - The SDA component is |
| | called with this value when an Update |
| | fails to complete. The SDA component |
| | has the opportunity to undo the changes |
| | that it did during an update. |
| string PostActionManifestXml | XML present in the PostAction |
| | section |
| string ProductName | Product Name |
| string Version | Deployment Version |

In some embodiments, SDA components may be invoked in situations other than an install or uninstall. For example, in one embodiment one or more SDA components may be invoked when a check for an update is made, even if there is not an update to install. In one embodiment, a user may manually invoke one or more SDA components outside of an install or uninstall processes. Each of these embodiments may have one or more InstallationStatus argument values other than those described in Table 1, to indicate the context of the invocation.

There are a number of options that may be used to handle failure during an installation operation. In one embodiment, if a failure occurs during an initial installation, deployment manager 240 may perform an uninstall; if a failure occurs during an update, deployment manager 240 may perform a roll back to the previous installed version. An uninstall may include deleting files that have been downloaded or reverting other actions that have been performed. A roll back may include deleting files that have been downloaded for the current version, reverting other actions that have been performed, or restoring the user application cache so that the application uses the files and data of the previous version.

In one embodiment, as part of a roll back, deployment manager 240 may invoke each SDA component that has been invoked and successfully completed during the current install. Each invocation may indicate that a roll back is in progress, such as by passing an argument with a status of roll back. The SDA component may then perform actions to reverse the actions it performed. This may include deleting copies of files, moving files, changing or deleting registry entries, making changes to a database, or other actions. In one embodiment, each SDA component may include logic to reverse each of the update changes it made. In one embodiment, an SDA component may include logic to revert update changes made for other SDA components. SDA components are not limited to reverting changes, however. They may perform other types of actions, such as writing entries to a log or a system even database, sending messages or engaging in transactions with remote devices, or other actions. In one embodiment, deployment manager 240 may perform actions during a roll back that substitute for roll back actions an SDA component may perform. For example, an SDA component may modify a file in the folder corresponding to an application version. If deployment manager 240 deletes the file, there is no need for the SDA component to revert its modifications.

An uninstall may be triggered by a user command, by a failed initial installation, or another triggering event. The actions of an uninstall may be similar to those of a roll back, as described above. Each SDA component of the current application version may be invoked, with an indication that an uninstall is in progress. The SDA component may perform uninstall actions, such as deleting files, changing or deleting registry entries, making changes to a database, or other actions. As discussed for a roll back, uninstall actions may include writing entries to a log or system event database, communicating with a remote device, or other actions. Unlike a roll back, in an uninstall, files installed during previous installs of the application may be deleted. As discussed for the roll back, deployment manager 240 may perform actions during an uninstall that substitute for uninstall actions of an SDA component.

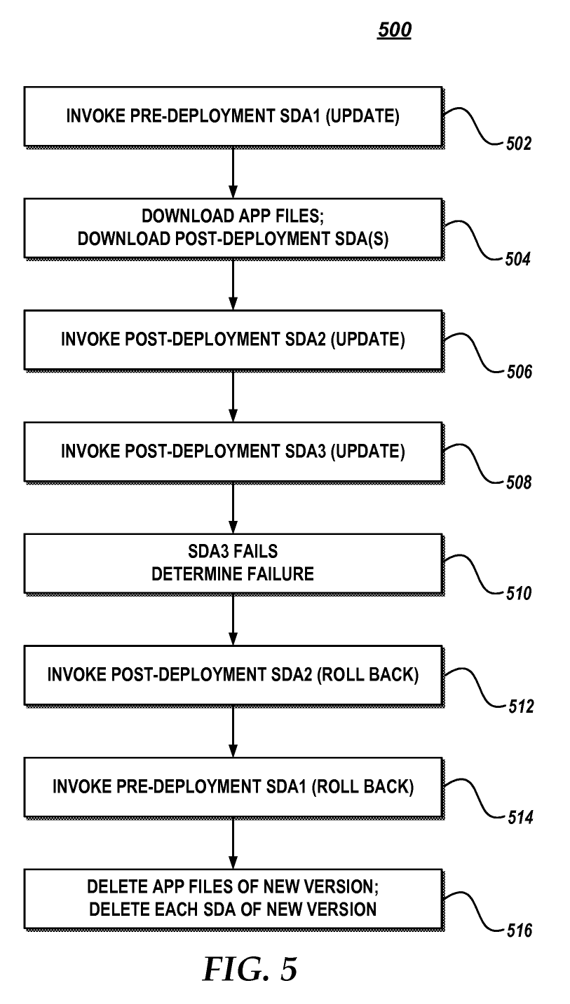

FIG. 5 is a flow diagram illustrating an example sequence 500 that may occur with an SDA component failure in one specific configuration. In the example configuration, there is one pre-deployment SDA component (“SDA1”), and two post-deployment SDA components (“SDA2” and “SDA3”). The sequence may begin at block 502, where the pre-deployment SDA component (“SDA1”) is invoked with an argument of “update.” At block 504, deployment actions of downloading application files and SDA component files of the new version are performed. These may be the actions of block 414, of FIG. 4.

At block 506, post-deployment SDA2 is invoked with an argument of “update.” At block 508, post-deployment SDA3 is invoked with an argument of “update.” In the example sequence, at block 510, SDA3 fails and returns a status value indicating failure. Prior to returning, SDA3 may perform actions to roll back any actions it performed prior to failure.

The process may determine the failure of SDA3 and, based on the failure, continue at block 512, where post-deployment SDA2 is invoked with a status of “roll back.” Thus, the process selectively performs roll back actions based on the result of the SDA actions. SDA2 may perform actions to roll back its previous update actions. At block 514, SDA1 may be invoked with a status of “roll back.” SDA1 may perform actions to roll back its previous update actions. In the illustrated embodiment, each SDA component that successfully completed is invoked with a status of “roll back” in the reverse order that they were invoked with a status of “update,” though in one embodiment the order may be the same as for the updates. In one embodiment, the sequence may continue at block 516, where each application file of the new version is deleted from the user application cache. Each SDA component of the new version may also be deleted. Other actions may be performed to roll back the update activity. In one embodiment, the actions of block 516 are not performed, and the application is updated, though the update actions of each SDA component have been rolled back.

In one embodiment, each of the SDA components may determine, in response to a roll back invocation, whether to roll back its corresponding actions. For example, one SDA component may include logic to roll back its update actions, though another SDA component may allow its update actions to remain in the event of a roll back. Thus, the specific actions that occur are based on the logic of each SDA component.

It will be understood that each block of the flowchart illustrations of FIGS. 4 and 5, and combinations of blocks in the flowchart illustrations, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-based method of installing a version of an application on a computing device having a user application cache corresponding to a user, a global application cache, and a set of privileges corresponding to the user and the application, comprising:
a) retrieving a set of application files to the user application cache, the set of application files including a manifest file that specifies at least one supplementary deployment action component;
b) performing deployment actions corresponding to the version of the application;
c) for each of the specified supplementary deployment action (SDA) components, performing a set of actions including:
i) selectively retrieving the SDA component to the user application cache; and
ii) invoking the SDA component from either the user application cache or the global application cache, based on the selective retrieval of the SDA component to the user application cache, the SDA component enabled to perform supplementary actions based on the set of privileges; and
d) selectively configuring the application to use the set of application files.

2. The computer-based method of claim 1, the deployment actions performed by a deployment manager, the set of privileges enabling the SDA component to perform actions that are not available to the deployment manager.

3. The computer-based method of claim 1, further comprising automatically selectively re-invoking at least one of the SDA components based on a status of invoking another one of the SDA components;

4. The computer-based method of claim 1, further comprising automatically selectively re-invoking at least one of the SDA components from the user application cache based on a status of invoking another one of the SDA components from the global application cache.

5. The computer-based method of claim 1, the SDA component from the global application cache installed during an installation of another application.

6. The computer-based method of claim 1, further comprising invoking at least one of the SDA components before performing the deployment actions.

7. The computer-based method of claim 1, the application files including an application assembly, further comprising invoking at least one SDA component from the application assembly.

8. A computer-based method of updating an application installed on a computing device comprising:
a) determining whether an update version of the application is available;
b) determining whether the update version is trusted;
c) if the update version is available and trusted, performing the method of claim 1.

9. A computer-readable storage medium comprising computer program instructions for installing a version of an application on a computing device having a prior version of the application installed in a user application cache corresponding to a user and a set of privileges corresponding to the user and the application, the program instructions executable by a processor to perform actions including:
a) retrieving a set of application files to the user application cache;;
b) selectively retrieving a supplementary deployment action (SDA) components to the user application cache;
c) performing deployment actions corresponding to the version of the application;
d) if the SDA component is retrieved to the user application cache, invoking the SDA component from the user application cache;
e) if the SDA component is not retrieved to the user application cache, invoking the SDA component from a global application cache;
f) configuring the application to use the set of application files;
g) selectively rolling back actions performed by the SDA component;

10. The computer-readable storage medium of claim 9, selectively rolling back actions comprising if another SDA component fails, invoking the SDA component to roll back the actions.

11. The computer-readable storage medium of claim 9, the SDA component integrated with one of the set of application files, invoking the SDA component comprising invoking instructions in the one of the set of application files.

12. The computer-readable storage medium of claim 9, selectively rolling back actions comprising selectively invoking the SDA component with a specification that roll back actions are to be performed.

13. The computer-readable storage medium of claim 9, further comprising selectively invoking the SDA component with a specification to perform uninstall actions.

14. The computer-readable storage medium of claim 9, further comprising:
a) invoking the SDA component from the global application cache; and
b) after configuring the application to use the set of application files, performing a second installation, performing the second installation comprising:
i) retrieving a new set of application files and a new version of the SDA component to the user application cache;
ii) invoking the new version of the SDA component from the user application cache; and
iii) configuring the application to use the new set of application files.

15. A computer-based system for installing a version of an application on a computing device having a user application cache corresponding to a user and a set of privileges corresponding to the user and the application, the system comprising:
a) retrieval means for retrieving manifest data and a set of application files to the user application cache, the retrieval means selectively retrieving one or more supplementary deployment action (SDA) components from a set of SDA components specified in the manifest data to the user application cache;
b) a deployment manager that performs deployment actions corresponding to the version of the application;
c) invocation means for invoking each of the set of specified SDA components, comprising means for selectively invoking each of the set of specified SDA components from a global application cache;
d) roll back means for automatically selectively rolling back actions performed by each of the set of specified SDA components;

16. The computer-based system of claim 15, each of the set of specified SDA components enabled to perform actions in accordance with the set of privileges including actions that are not available to the deployment manager.

17. The computer-based system of claim 15, the invocation means comprising means for selectively invoking each of the set of specified SDA components prior to the deployment actions of the deployment manager and means for selectively invoking each of the set of specified SDA components after the deployment actions of the deployment manager.

18. The computer-based system of claim 15, comprising means for determining whether the version of the application is trusted.

19. The computer-based system of claim 15, the roll back means comprising instructions to selectively invoke each of the set of specified SDA components based on a status of one of the set of specified SDA components.

20. The computer-based system of claim 15, one of the application files includes executable program code and an integrated SDA component, invoking the version of the SDA component comprising invoking instructions in the executable program code.
